(19) United States
(12) Patent Application Publication
(10) Pub. No.: US 2005/0139594 A1
(43) Pub. Date: Jun. 30, 2005

(54) Water heater

(76) Inventors: Nigel Jones, Swansea (GB); Kevin Smith, Swansea (GB)

Correspondence Address: STITES & HARBISON PLLC, 424 CHURCH STREET, SUITE 1800, NASHVILLE, TN, 37219-2376, US

(21) Appl. No.: 10/493,754

(22) PCT Filed: Oct. 18, 2002
(86) PCT No.: PCT/GB02/04728

(30) Foreign Application Priority Data
Oct. 27, 2001 (GB) 0125888.8
Mar. 22, 2002 (GB) 0206720.5

(51) Int. Cl. H05B 6/80

(52) U.S. Cl. 219/687

(57) ABSTRACT

A water heater or boiler, comprising a conduit (2) having an inlet (10) and an outlet (20), means for causing water to flow h said conduit (2) from said inlet (10) to said outlet (20), and one or more radio frequency wave heating sources (3) arranged such that water is heated thereby as it flows through said conduit (2) from said inlet (10) to said outlet (20). The radio frequence wave heating source (3) is preferably a microwave heating source, and the apparatus may include one or more waveguides (7) for directing the microwaves towards the conduit (2). The invention provides a water heater or boiler which can heat water on demand (but required the need for a storage tank or the like) using microwave or other radio frequency heating source. One or more microwave radiation absorption members (not shown), such as a metal rod or piece of wire wool, may be disposed in the water to be heated to significantly increase the efficiency of the heater.

This invention relates to a water heater and, more particularly, to a highly efficient, relatively safe, relatively low maintenance water heater for use in both commercial, domestic and industrial environments.

Electric water heating devices or boilers are well known. Such devices generally comprise a water tank for holding a predetermined volume of cold water for heating, and the water tank is conventionally lagged or surrounded by a thermally insulating outer casing. Within the tank is provided an electric resistance or element which becomes hot when electrical current is passed therethrough and heats the water within the tank to a predetermined desired temperature.

Such electric water heating devices are conventionally used in environments where space and ventilation are minimal because they are generally considered to be relatively safe in operation. However, there are a number of disadvantages associated with this type of water heater, as follows. Firstly, electricity is a relatively expensive power source; and secondly, the electric element quickly becomes covered with limescale which greatly reduces its heating efficiency, which drawback can only be alleviated by frequent maintenance operations to clean or replace the element. As a result of both of these issues, the operation and maintenance costs of an electric water heater or boiler are comparatively high.

In environments where space is not necessarily limited, and where sufficient ventilation can be readily provided, it is more common to employ gas water heaters or boilers, largely because gas is a relatively low-cost power source in comparison to electricity. Again, many such devices generally comprise a large water tank for holding a predetermined amount of water to be heated, the tank being surrounded by some form of thermally insulating material, as in the case of an electric water heater or boiler. However, another type of gas boiler, namely the combination boiler, exists which heats water on demand and does not require a water tank as such. Although such devices are smaller than the traditional water tank arrangements, they are still relatively large and cumbersome making them unsuitable for some smaller environments.

Although gas water heaters tend to be much cheaper to operate than their electric equivalents, they still have a number of disadvantages associated with them. Firstly, the installation of a gas water heater or boiler requires adherence to very stringent ventilation and other safety regulations. In particular, the device must be provided within an environment which is suitably ventilated to prevent the build up of dangerous combustion products resulting from the burning of gas. Secondly, this type of water heater or boiler, especially the combination type gas boiler, still suffers from the problems associated with a large build up of limescale which greatly reduces its heating efficiency and can only be overcome by regular maintenance and replacement of components.

European Patent Application No. 0849546 describes a water heater comprising a water tank for holding a predetermined volume of water to be heated and a microwave heating source for heating the water in the tank. One of the main advantages of employing a microwave heating source for this purpose is the substantial reduction in the build up of mineral deposits within the equipment, thereby substantially reducing the maintenance costs thereof. As such, the water heating equipment described in the above-mentioned document is intended to provide a water heating capability which is relatively efficient and remains so over long periods of time.

However, the arrangement described in European Patent Application No. 0849546 still suffers from the drawback that the equipment is relatively large and cumbersome and, as such, can only be installed in an environment where a sufficiently large area is available. Further, it takes a relatively long period of time to heat a whole tank full of water to the required temperature and, as such, is unsuitable for use in a situation where hot water is required substantially immediately.

U.S. Pat No. 4,152,567 describes water heating apparatus comprising a resonant cavity having a magnetron (or microwave energy source) coupled thereto. The resonant cavity has an inlet for allowing cold water to flow into the resonant cavity for heating by the microwave energy source, and an outlet for allowing the heated water to flow back out of the resonant cavity for use as required. Grid wires are provided across the inlet and outlet to prevent radiation from propagating down the water pipe leading into the inlet and the outlet and, as such, have openings therein less than a half-wave length of the radiant energy at the operating frequency of the magnetron. The grid wire structure is intended to provide electrical continuity within the heating cavity and achieves microwave shielding while allowing water to flow through the heating system without fluid flow impairment.

However, this system suffers from a number of drawbacks. Firstly, if the water is permitted to flow through the resonant cavity at the same rate as it is fed from a standard water supply, it is unlikely to be heated to a sufficient temperature while it is in the resonant cavity to make it suitable for use in many commercial and domestic applications. Secondly, the requirement for the grid wire structure renders the overall system unnecessarily complex, expensive and susceptible to failure.

We have now devised an arrangement which overcomes all of the problems outlined above.

Thus, in accordance with the first aspect of the present invention, there is provided fluid heating apparatus comprising a heating cavity and at least one substantially fluid-tight pipe or channel within said heating cavity, the pipe or channel having an inlet and an outlet, means for causing fluid to flow or pass through said pipe or channel from said inlet to said outlet, and one or more radio frequency wave heating sources arranged to emit electromagnetic radiation into said heating cavity such that fluid is heated thereby as it flows through said pipe or channel from said inlet to said outlet.

Also in accordance with the first aspect of the present invention, there is provided a method of heating fluid comprising the steps of providing a heating cavity and a substantially fluid-tight pipe or channel within said heating cavity, the pipe or channel having an inlet and an outlet, causing fluid to flow through said pipe or channel from said inlet to said outlet, applying radio frequency wave radiation into said heating cavity around said pipe or channel such that fluid is heated thereby as it flows through said pipe or channel from said inlet to said outlet.

The fluid is preferably a liquid, for example water or a water-based liquid.

Thus, since the fluid flowing or passing through the pipe or channel is isolated from the electromagnetic radiation heating source, no additional microwave shielding is required in the pipe or channel (or conduit) or at the inlet or outlet thereof. Further, the diameter of the conduit at the inlet and outlet is sufficiently narrow to prevent radiation leakage therethrough, thereby eliminating the need for a grid wire structure or similar leakage prevent means at the inlet and outlet.

The term ‘radio frequency’ is well understood in the. art to mean any frequency of electromagnetic radiation in the range between 3 kHz and 300 gigahertz inclusive. However, the preferred heating source in this case is radio frequency in the range 100 MH_{z} to 100 GH_{z}, more preferably 100 MH_{z} to 10 GH_{z}, and more preferably around 300 MH_{z} to 3 GH_{z}, for example, a microwave heating source.

Thus, the first aspect of the present invention provides a fluid (e.g. water) heater which is small, efficient, safe and low maintenance which preferably uses microwave energy as the heat source and heats fluid as it flows through a relatively small conduit such that water or other fluid can be heated on demand, which eliminates, the example, the need for a large storage tank to hold a volume of water to be heated. In other words, the heater of the present invention is operable for the case where large or small fluid volumes are required to be heated, and will provide fluid or heating facilities on demand if required with no hot fluid storage requirements.

The heater of the first aspect of the present invention is suitable for use in both domestic and commercial environments, and is sufficiently flexible to be able to provide hot fluid, such as water to a complete building or environment, or just selected areas thereof according to requirements. In other words, the apparatus of the present invention can be in-line, providing heat or hot water to one heat unit or water tap, or it can be used as a central feeder for more than one heat unit or water tap. In any event, the apparatus of the present invention is capable of providing heating or hot water, or other fluid on demand, thereby eliminating the need for any pre-heating of fluid housed in a storage tank.

One exemplary embodiment of the first aspect of the present invention may comprise a portable water heater, which may be powered by, for example, battery or solar power, and which can supply hot water in an environment where no other means to heat an existing water supply is available and/or where an independent water container exists or accompanies the present invention in accordance with one exemplary embodiment thereof.

The apparatus according to the first aspect of the invention may be arranged to heat fluid to a variety of different (selectable) temperatures, possibly in a range between around 20° C. to around 500° C. or more, such that the apparatus could be used to sterilise water if required. Such sterilisation apparatus may be provided in conjunction with a water storage tank if necessary (i.e. water sterilised in transit through the conduit included in the present invention could be transported to and stored within an airtight storage container for future use as required).

Once the required fluid temperature is selected (either by a user or by the system designer) heating of the fluid flowing through or passing the system is preferably controlled by a control unit which may be arranged to control the rate of flow of fluid into and therefore through the heating area (thereby controlling the period of time for which the fluid is in the heating area being heated). However, in a preferred embodiment, control means are provided for controlling at least the frequency of the radio frequency source (and optionally also the flow of fluid into the system) according to the fluid temperature required to be attained.

In any event, in the case of a possible variable flow rate of fluid into the system, sensors are preferably provided to detect such flow rate and/or outlet temperature. The output(s) of such sensor(s) are preferably fed to the control means to control flow rate and/or frequency of the RF source so as to obtain a substantially constant fluid temperature at the outlet. [symbol] frequency of the RF heating source, in the case of a water heater, is likely to be that which makes the skin depth in a domestic/commercial water supply the same order of magnitude as the conduit diameter. This can be easily calculated by a person skilled in the art, but may be close to a magnetron frequency of around 1 GH_{z} or more.

The conduit may comprise a helical or otherwise shaped tube or channel, or network of channels or tubes, of any suitable, thermally conductive material, for permitting fluid flow therethrough. Alternatively, or in addition, the conduit may comprise one or more chambers.

One or more waveguides may be provided to aid in the efficient transmission and direction of the radio frequency waves emitted by the heating source towards the conduit through which the fluid to be heated is flowing or passing. In a preferred embodiment, it is the commencement of flow of fluid through the conduit (caused, for example, by the turning on of the or a tap connected to the heater or by the switching on of a or the heating unit connected to the heater) which triggers the operation of the radio frequency wave heating source. The heating cavity may comprise or include a single mode waveguide (having a single heating location) and/or a multiple mode waveguide (having a plurality of heating locations). In either case, means may be provided for slowing or delaying the flow of fluid through the heating cavity at the, or one or more of the heating locations. Alternatively, or in addition, means may be provided for stopping and holding a body of fluid at the, or one or more of the heating locations, such that a fixed body of fluid is heated.

The apparatus preferably includes cooling means for drawing cooling gas across the heating source to cool said source. In a preferred embodiment, the gas (once warmed by the passing thereof across the heating source) may be directed towards the conduit through which water is flowing in order to aid in the heating thereof. Alternatively, or in addition, the apparatus may include outlet means for venting said warmed gas. The conduit may be wrapped around or otherwise disposed adjacent to the heating source, so that heat generated thereby is directly transferred via the conduit to the fluid therein, although additional cooling means may also be provided.

The apparatus preferably includes a chamber or similar housing in which electronic control means, such as temperature control, timer and safety electronics may be housed, as required. The apparatus may further comprise a removable panel which allows access to one or more components of said apparatus, removal of said panel being beneficially arranged to render said apparatus inoperable until said panel is replaced. One or more of the elements of the heater, particularly the conduit and heating source (and waveguide(s) if applicable), are preferably housed within a casing of electrically conductive material which is intended to prevent interference from unwanted electrical disturbances, more preferably a Faraday cage which is an earthed wire or metal screen completely surrounding the apparatus such that no electric field can be produced within the housing by external electric charges and no radio frequency waves can leak therefrom.

In accordance with the second aspect of the present invention, there is provided heating apparatus for emitting heat into the surrounding atmosphere, said apparatus comprising a thermally conductive housing containing a body fluid therein, when in use, and one or more radio frequency heating sources for heating said body of fluid in said housing, heat from said body of fluid being conducted to said housing and from said housing into the surrounding atmosphere.

The fluid is preferably a fluid, most preferably, water or a water-based fluid.

An addition to the present invention provides a means of heating, by RF, a radiator containing fluid designed in such a way as to act as a RF chamber. The one or more radio frequency heating sources would preferably be an integral part of the heating apparatus or “radiator”. The apparatus might, beneficially include means for cooling said one or more RF heat sources and/or means for venting war air, and/or means for transferring the RF waves into the fluid chamber defined by the internal confines of the housing, causing the fluid to heat. A small pump may be added (but not necessarily) to agitate the heated fluid within the radiator or cause it to circulate therein, preferably through a waveguide supporting a radio frequency heating source.

The RF heat source(s) could be mains, generator and/or battery powered allowing use in domestic and commercial environments or where mains electricity is not available such as portable buildings or remote buildings.

This aspect of the invention would allow the installation of a single unit or a multiple of units whereby the unit or units could be intelligently controlled by a central control unit or locally on each individual unit or both. The central control method would preferably be wireless so as to eliminate the need for hard wiring.

Such a radiator could be drained for transit from a drainage plug suitably positioned, and refilled via a fill plug.

The heating apparatus of the second aspect of the invention essentially eliminates the need for plumbing equipment and a central heating system as traditionally used for gas heating. This significantly reduces the materials required to develop a domestic or commercial heating system, and by using RF technology the heating process would be highly efficient and significantly less costly. Maintenance costs would also be significantly reduced and threat of system breakdown causing flooding would be reduced.

No exhaust gases are generated, so no vent system is required as is the case with gas central heating systems.

Another benefit of the second aspect of the invention is the elimination of scale build up enhancing system efficiency.

The described radiator can be moved at any time and relocated in another part of the room or building without the need for plumbing. It can be controlled so that any number of radiators could be operated at any or different times via control unit that allow complete flexibility.

The radiator design can be flexible and variable to suit any number of applications or styles or it could be standard. In each case, the design ensures optimum heating efficiency.

The second aspect of the invention can be extended to use in auto vehicles where the heating apparatus, designed accordingly, can be used to preheat the vehicle cabin prior to occupation and independent of the vehicle engine. Additionally, such RF heating apparatus can be incorporated into the engine cooling system allowing the preheating of the cooling water so as to assist and make more efficient engine start-up. In both these cases, the RF heat source can be activated remotely or locally by timer.

In accordance with a third aspect of the present invention, there is provided fluid heating apparatus comprising a heating cavity and one or more radio frequency wave heating sources arranged to emit electromagnetic radiation into said heating cavity such that a body of fluid disposed therein or fluid flowing therethrough is heated, the apparatus further comprising one or more aerials disposed within the body or flow of fluid to be heated, the or each aeriel comprising a member arranged to transmit or receive electromagnetic waves.

Also in accordance with the third aspect of the present invention, there is provided a method of heating fluid, comprising the steps of providing a heating cavity within which is disposed a body of fluid to be heated or through which fluid to be heated is caused to flow or pass, emitting radio frequency wave radiation into said heating cavity such that said fluid is heated thereby, and providing one or more aerials within said body or flow fluid, the or each aerial comprising a member arranged to transmit or receive electromagnetic waves.

The fluid is preferably a liquid, such as water or a water-based liquid.

Once again, the radio frequency wave radiation is preferably microwave radiation, and the fluid is preferably water.

The provision of one or more aerials within the body or flow of fluid to be heated significantly increases the efficiency of the heating process. In one specific embodiment, the aerial(s) may comprise at least partially, preferably solid, metal member(s) such as one or more metal rods, tubes, pipes, wires or metal pieces or filings. Alternatively, or in addition, the aerial(s) may at least partially comprise a member made of carbon, or other suitable non-metallic material.

The effect of providing one or more aerials is to concentrate the radio frequency energy within the body/flow of fluid by reception (and/or transmission) of the radio frequency energy. This increases the speed at which the temperature of the fluid rises and increases the amount of energy produced by the radio frequency source that is actually absorbed by the fluid, thereby increasing the efficiency of radio frequency heating.

The provision of one or more aerials within the systems of the first and second aspects of the invention would enhance the performance of such systems, but this innovation may have many other applications.

Embodiments of the present invention will now be described by way of examples only and with reference to the accompanying drawings, in which:

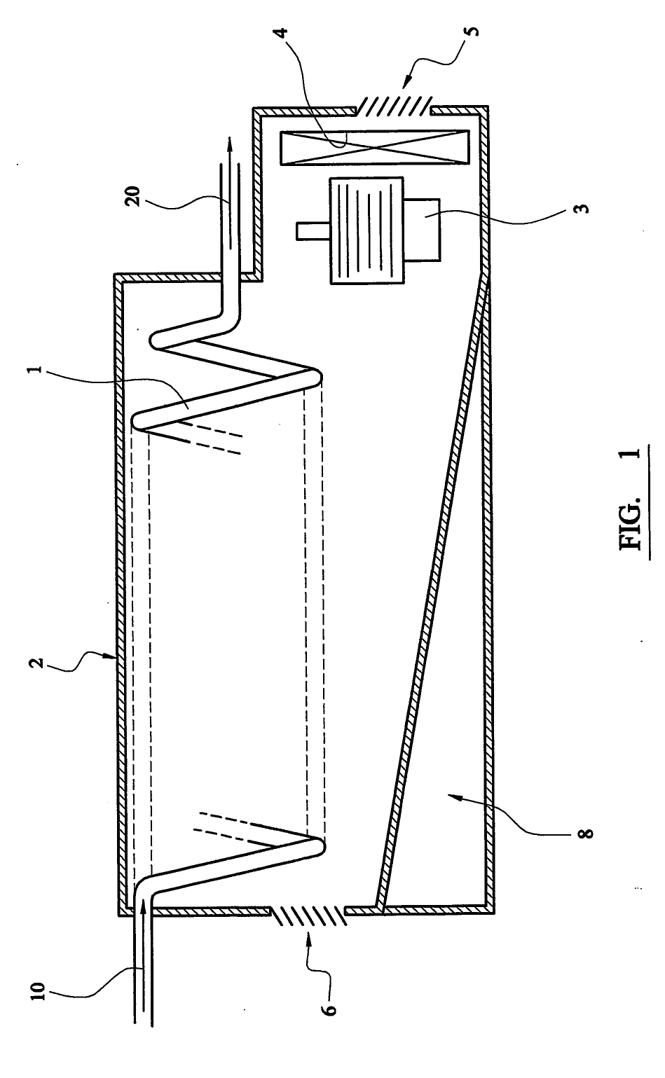

FIG. 1 is a schematic cross-sectional view of a water heater according to a first exemplary embodiment of the first aspect of the present invention;

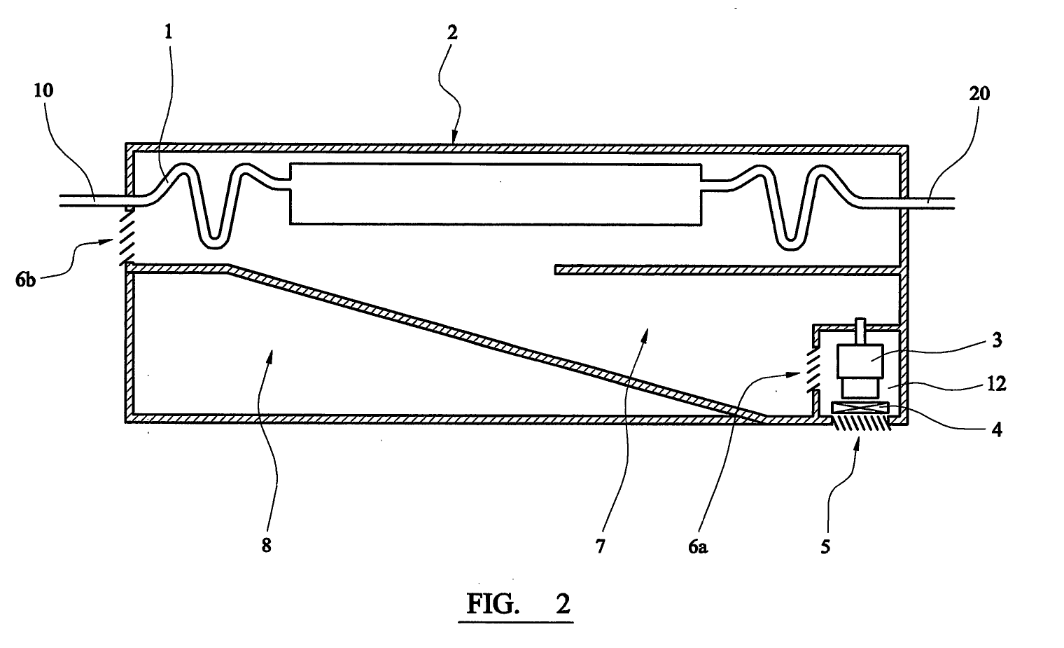

FIG. 2 is a schematic cross-sectional view of a water heater according to a second exemplary embodiment of the first aspect of the present invention;

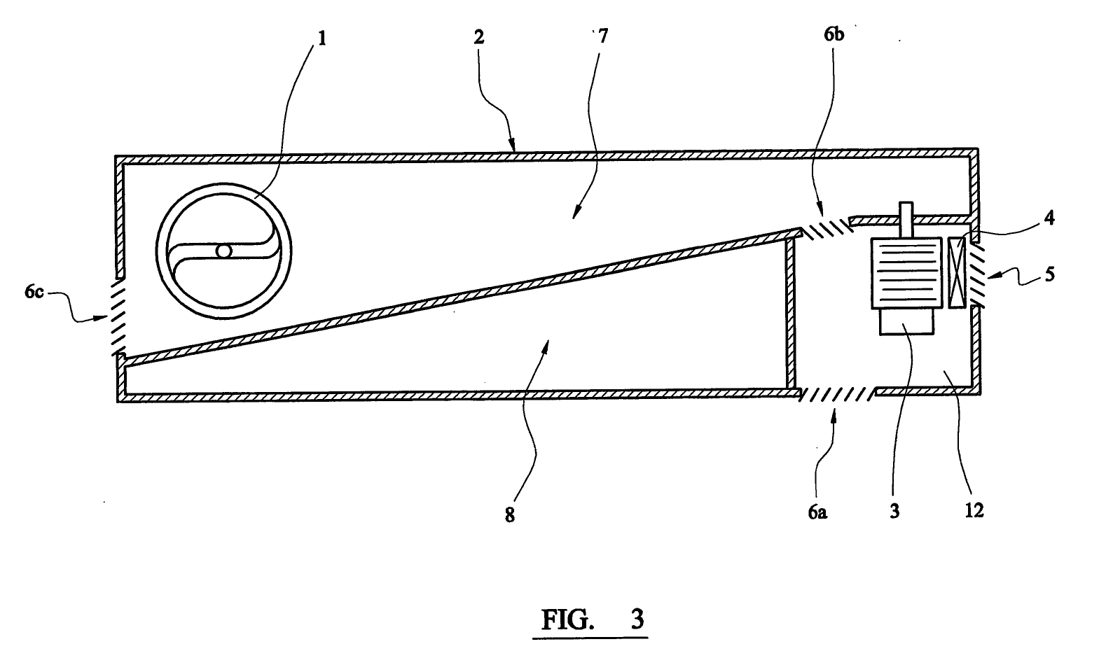

FIG. 3 is a schematic cross-sectional view of a water heater according to a third exemplary embodiment of the first aspect of the present invention;

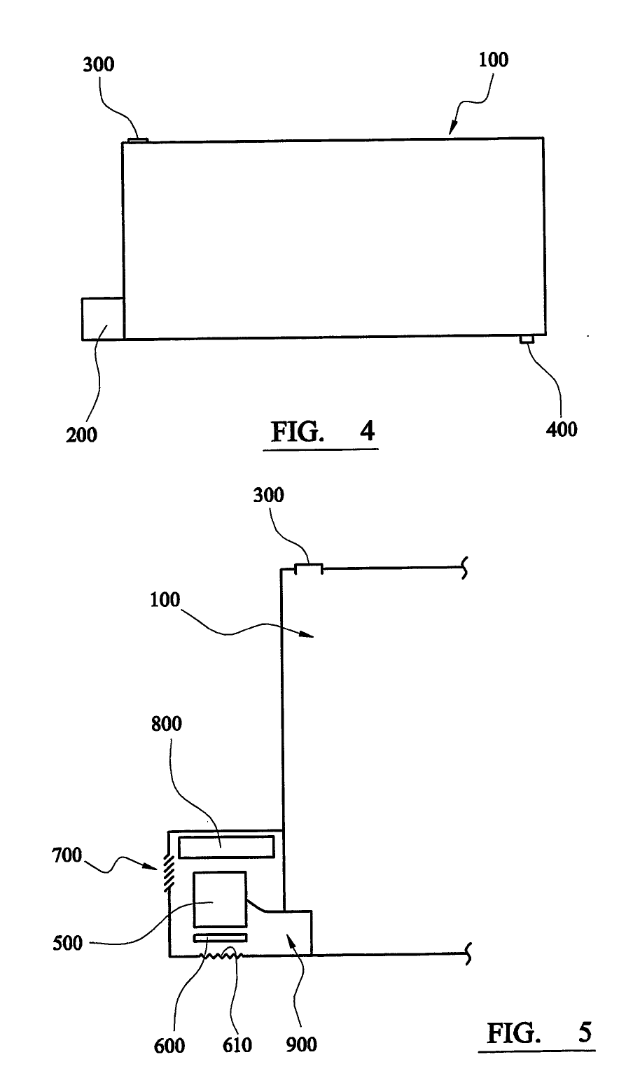

FIG. 4 is a side view of heating apparatus according to an exemplary embodiment of the second aspect of the present invention;

FIG. 5 is a schematic partial side cross-sectional view of the apparatus of FIG. 4;

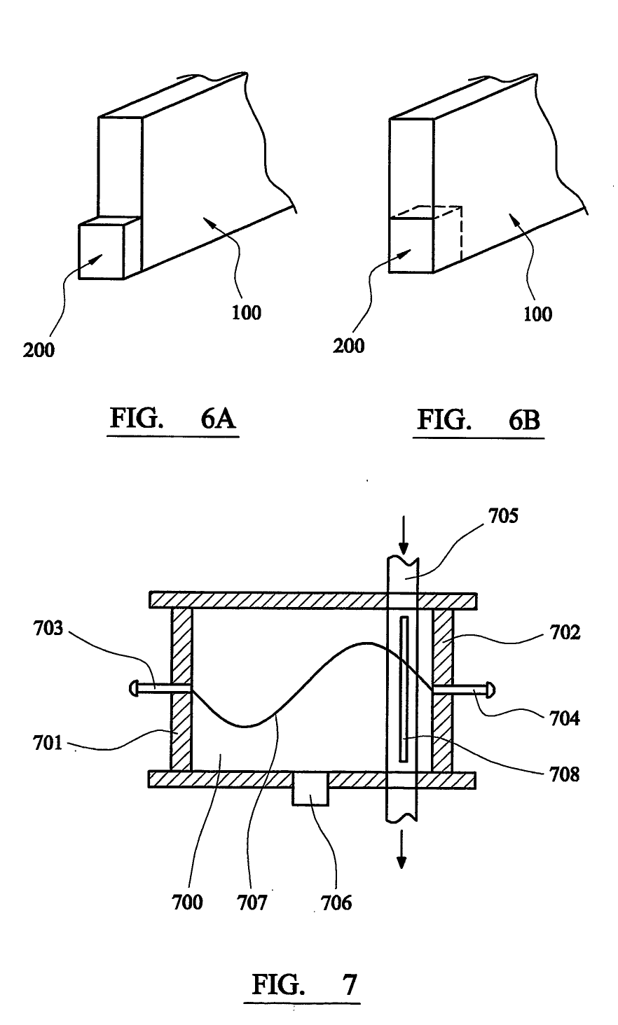

FIG. 6A is a partial perspective view of the apparatus of FIG. 4; and

FIG. 6B is a partial perspective view of an alternative exemplary embodiment of the second aspect of the present invention.

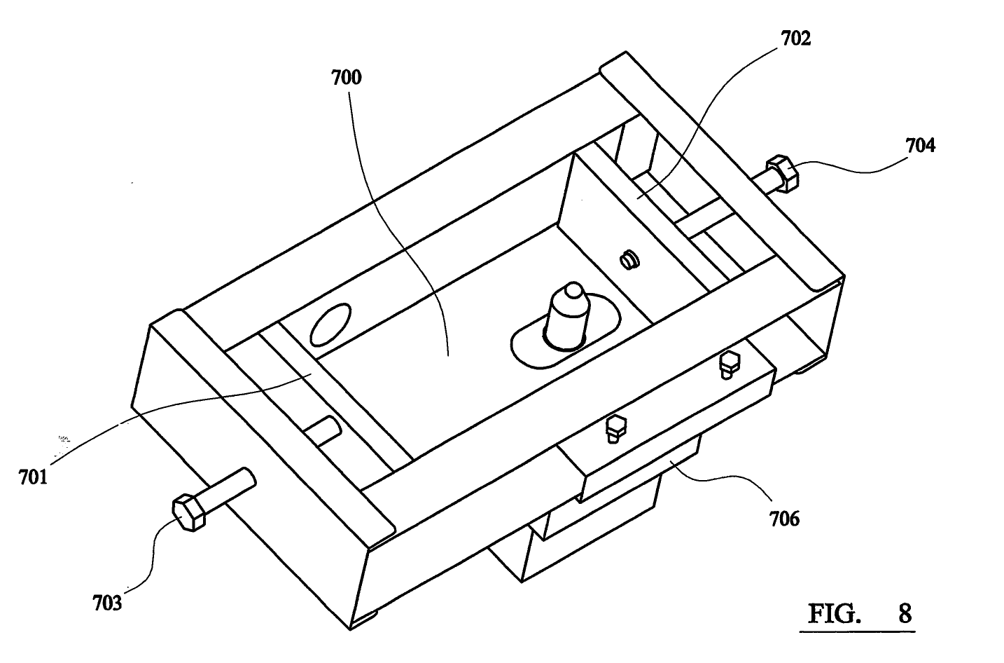

FIG. 7 is a schematic cross-sectional side view of heating apparatus according to an exemplary embodiment of the third aspect of the present invention;

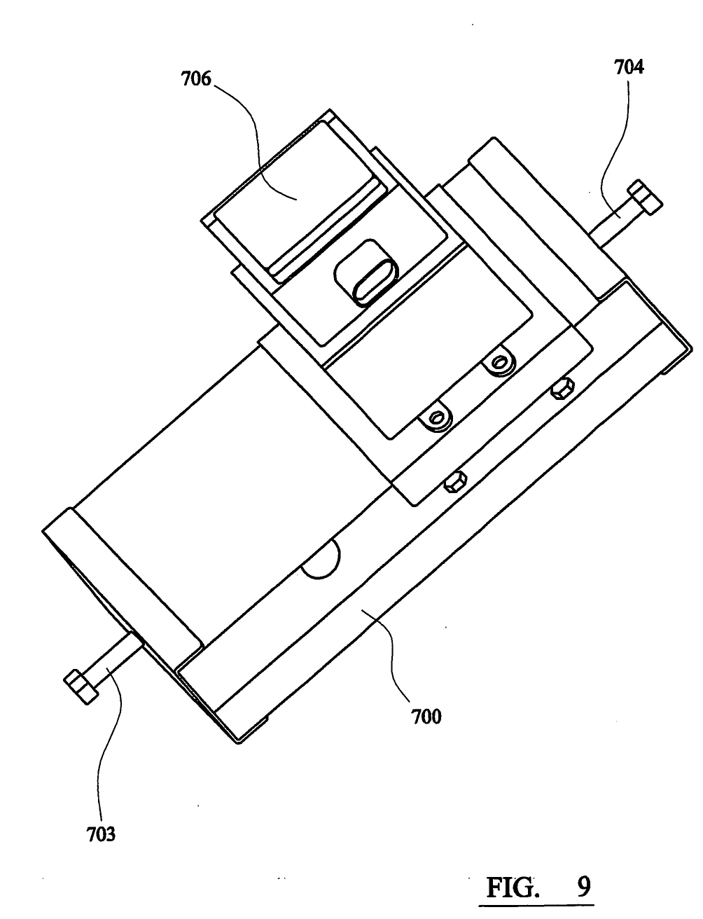

FIG. 8 is a schematic perspective plan view of heating apparatus according to an exemplary embodiment of the present invention;

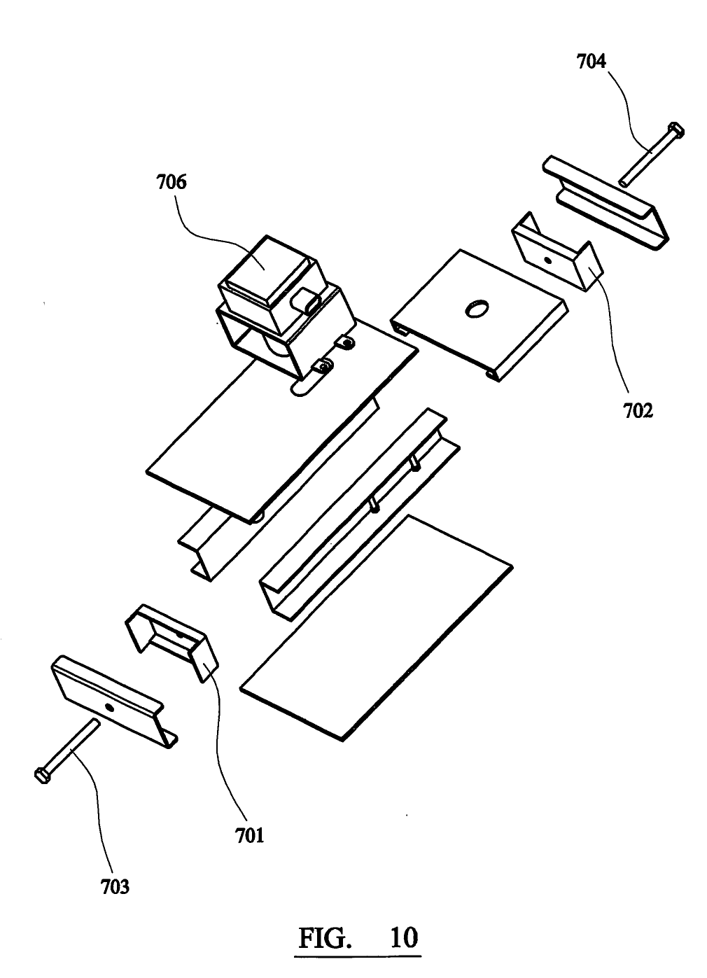

FIG. 9 is a schematic perspective bottom view of the apparatus of FIG. 8; and

FIG. 10 is a schematic perspective view of the apparatus of FIG. 8, illustrating its component parts.

Referring to FIG. 1 of the drawings, a water heater according to a first exemplary embodiment of the first aspect of the present invention comprises a housing 2 of, for example, metal or shielded polymer material. Housed within the housing 2 is a helical pipe or channel 1 having an inlet 10 and an outlet 20. Also housed within the housing 2 is a microwave radiation source in the form of a magnetron 3 which is a crossed-field microwave tube that produces radio frequency oscillations in the microwave region. The magnetron 3 may be powered from the mains electricity supply within the environment in which the water heater is installed. Alternatively, or in addition, it may be battery-powered and/or solar-powered, according to requirements and availability of components.

A cooling fan 4 is provided in close proximity to the magnetron 3 so as to prevent the magnetron from overheating during prolonged operation. The housing 2 is provided with an air inlet 5 and an air outlet 6, and the cooling fan 4 operates to draw cooling air from outside the housing 2 into the housing 2 through the air inlet 5, across the magnetron 3 and then expel the warmed air from inside the housing 2 through the air outlet 6.

The housing 2 is further provided with a separate chamber 8 for housing the necessary electronic components (not shown) required for controlling the water heater.

In use, power is supplied to the magnetron 3 which operates to produce microwave radiation and emit said radiation within the housing 2. The microwave radiation generated by the magnetron 3 acts to heat water which is flowing through the helical channel 1 between the inlet 10 and the outlet 20. Thus, the water is heated as it flows through the channel 1 and no storage tank is required: the water can simply be pumped to wherever it is required for use directly from the water heater.

Referring to FIG. 2 of the drawings, a water heater according to a second exemplary embodiment of the first aspect of the invention is similar in many respects to the embodiment described with reference to FIG. 1, and like components are denoted by the same reference numerals. Thus, the water heater comprises a housing 2 of metal or shielded polymer material within which is housed a channel 1 having an inlet 10 and an outlet 20. The channel 1 may be entirely helical as described with reference to the first exemplary embodiment. However, it may alternatively be only partially helical (for example, proximate the inlet 10 and the outlet 20 only), with the remainder of the channel 1 being substantially straight, as shown. In yet another embodiment, the channel 1 may not be helical at all, but instead of wider diameter than the inlet 10 and outlet 20 to slow the flow of water between the two.

In this embodiment, a large proportion of the microwave power source 3 is housed in a separate chamber 12 within the housing 2, with only a small portion of the magnetron protruding through an opening of the chamber 12 into the main body of the housing 2. A cooling fan or other cooling device 4 is provided within the magnetron chamber 12, which includes an air inlet 5 for permitting air from outside the housing 2 to enter the magnetron chamber 12 and an air outlet 6a for expelling air therefrom. The cooling fan operates to draw cool air through the inlet 5 into the magnetron chamber 12, across the magnetron unit to cool it and expel the resulting warm air from the magnetron chamber 12 into the main body of the housing 2.

Also provided within the housing 2 is a waveguide 7 for directing microwave radiation generated by the magnetron 3 (and the warm air expelled from the magnetron chamber 12 during the cooling process) towards the channel 1. A second air outlet 6b is provided in the housing wall for expelling air from the housing 2. In use, once again, power is supplied to the magnetron 3 which operates to produce microwave radiation and emit said radiation into the area within the housing 2 between the waveguide 7 and the magnetron chamber 12. The microwave radiation generated by the magnetron 3 is directed by the waveguide 7 towards the channel land acts to heat water which is flowing therethrough between the inlet 10 and the outlet 20. During operation, the cooling fan 4 is operated to draw cool air into the magnetron chamber 12, across the magnetron 3 to cool it and out of the air outlet 6b into the housing 2. The expelled warm air is directed by the waveguide 7 towards the channel 1 and provides an additional heating source to assist in the heating of the water therein. Thus, the water is efficiently heated as it flows through the channel 1 and no storage tank is required: the water can simply be pumped to wherever it is required for use directly from the water heater.

Referring to FIG. 3 of the drawings, a water heater according to a third exemplary embodiment of the first aspect of the present invention is once again similar in many respects to the embodiments described with reference to FIGS. 1 and 2, and like components are denoted by the same reference numerals. In this case, however, the conduit through which water to be heated flows is provided in the form of a substantially cylindrical chamber 1 within the housing 2. A generally triangular chamber 8 is provided within the housing 2 for housing the electronic components required for controlling the water heater.

Once again, a magnetron chamber 12 is provided within which the magnetron unit is substantially housed, with only a small portion of the magnetron protruding from the top of the chamber 12 into the housing. The profile of the chamber 8 and the chamber 12 in combination provides a waveguide 7 for directing microwave radiation generated by the magnetron 3 towards the cylindrical chamber 1 through which water to be heated flows. Once again, a cooling fan 4 is provided within the magnetron chamber, which draws air into the magnetron chamber 12 through an inlet 5 and across the magnetron unit 3 to cool it. Warm air is then expelled from the magnetron chamber 12 through the air outlets 6a and 6b. Warm air expelled through the outlet 6b is directed by the waveguide 7 towards the cylindrical chamber 1 to assist in the heating of the water therethrough, and is then expelled through another air outlet 6c in the wall of the housing 2.

In the case of all three of the above-described embodiments, operation of the magnetron 3 is triggered by the flow of water through the conduit 1. The commencement of flow of water through the conduit 1 (which is achieved by, for example, somebody running a tap connected to the system) is detected by the electronic control circuit provided in the chamber 8, which then switches on the power supply to the magnetron 3 and triggers its operation. Thus, the water is heated and supplied upon demand. When the water ceases to flow through the conduit 1, this is detected by the control circuit, which switches off the power supply to the magnetron 3 such that it stops operating.

It will be appreciated that the size and position of the microwave (or other radio frequency wave) source is dependent on the intended application and requirements of any particular embodiment of the present invention; and the present invention is therefore not intended to be limited in this regard. It will also be appreciated that the chamber (or other unit) required to support or house the electronic control unit for the apparatus may be provided in or on the apparatus itself, or it may be provided entirely separately therefrom, according to user requirements and environmental considerations. Further, in the case where a waveguide is provided to direct the radio frequency waves towards the intended target, it will be appreciated that the size and design of such a waveguide will only be dependent on the design of the overall apparatus and is limited only in terms of the aim it is required to fulfill within such apparatus.

Referring to the FIG. 4 of the drawings, a heating apparatus or “radiator” according to an exemplary embodiment of the second aspect of the present invention comprises a housing 100 of a substantially thermally conductive material. Fluid, such as water, is introduced into the housing 100 via a fill plug 300, provided in the upper wall of the housing 100. When the housing 100 is filled to a predetermined level with water, the housing 100 is sealed for use, such that the water in the housing 100 comprises a substantially static body of water within the housing 100. A heating unit 200 is provided on a side wall of the housing 100, in communication with the interior thereof. The lower wall of the housing 100 may also be provided with a drainage plug 400 for permitting the drainage of the water so that it can be renewed, or the apparatus can be moved.

Referring to FIG. 5 of the drawings, the heating unit 200 comprises a box-like housing containing a radio frequency heating source 500. A waveguide 900 is provided for directing the radio frequency waves from the source 500 into the interior of the heating apparatus housing 100.

A cooling fan 600 is provided which draws cooling air into the heating unit via air inlet 610, across the radio frequency heating source 500, and expels the warm air from the heating unit via air outlet 700. Control electronics 800 are provided for controlling the operation of the radio frequency heating source, according to heating requirements selected by a user.

Referring to FIGS. 6A and 6B of the drawings, it can be seen that the heating unit 200 may be provided externally on the outside of the housing 100 (FIG. 6A). Alternatively, it may be provided inside the housing 100 (FIG. 6B).

The provision of one or more aerials in the flow or body of water would enhance the performance of all of the above-described systems. The aerial(s) may comprise metal rod(s), pipe(s), tube(s), wire(s), piece(s) of metal or wire wool and/or metal filings, although the choice of aerial will depend on several different factors.

At least three things happen when microwaves encounter a load: The energy can be reflected, transmitted, or absorbed depending on its properties. A load placed in a microwave cavity may therefore not heat at all, may heat quickly, may heat after a certain time (slow process), and/or generate hot spots. It is thus important to know beforehand the material properties as they determine the materials interaction with microwaves, ie whether it is opaque, transparent or Lossy.

Any homogeneous, isotropic, and linear dielectric material is characterised by a frequency—dependent absolute complex permittivity, known as the relative dielectric constant (e″). This is used as a relative measure of the microwave energy density in the material. The imaginary part e″″, known as the relative loss factor, accounts for all the internal loss mechanisms. It indicates how well a material absorbs energy from the electric field passing through it and how much energy is converted to heat. A lossy material with a high e″″ will therefore absorb energy well and heat quickly, provided that it has a small size with respect to the penetration depth. On the other hand, if the material has a very low e″″ the material becomes transparent. Therefore, materials with middle range values of e″″ (i.e. e″″<3) are suitable for dielectric heating, e can be used to indicate how much energy is reflected away from a material and how much is transmitted.

Taking these factors into consideration, experiments were set-up in the following order, 300 ml of tap water in a Pyrex beaker was placed in the centre of a domestic microwave oven, and set to full power (900 watts). Water reached 100 °° C. after 180 seconds. Apparatus was allowed to cool and again the beaker was filled to 300 ml mark. Two stainless steel rods each measuring 3 mm diameter and 150 mm in length were placed into the beaker and diagonally crossing and touching in the water with approx. ⅓ of its length protruding out of the beaker, again full power was applied. After approx. 30 seconds bubbles were forming around the diagonally crossed stainless steel rods submerged in water and reached 100°° C. after 120 seconds. Therefore, suggesting the rods were acting as antennas concentrating the energy, allowing the water to heat quicker.

Valuation

Water measured in kilos is 0.1 kg=100 ml.

Specific heat capacity of water=4.2×10³J/Kg⁻¹/K⁻¹
Q =mc(θ?₂−θ?₁)

This expression is useful in heat calculations and gives the quantity of heat (Q) taken in by a body of mass (m) and mean specific heat capacity (c) when its temperature rises from θ?₁ to θ?₂ it also gives the heat lost by the body when its temperature falls from θ?₂ to θ?₁.

In words, we can say:

Heat Given Out=Mass×Specific Heat Capacity×Temperature Change (or Taken Away)

Therefore, if a measured amount of water is taken to be m=0.3 kg and the approximate specific heat capacity of water at room temperature is 4.2×10³J/Kg⁻¹/K⁻¹ and θ?₁=15°° C. Heating that amount of water for a given time of 180 seconds gives θ?₂ to be 100°° C. giving D_{T}=85°° C.

We can say:
Q=mc D_{T}
Q=0.3×(4.2×10³)×85
Q=107,100J

Delivered energy (Power) from microwave if:
1 watt=1J/second.

Therefore, a 900 watt microwave delivers 900 J/second.
In 180 seconds=900×180=162,000J(Total)

Target absorbed=107,100J of produced J. Therefore, absorbing 66.1%

Heating water with a submerged stainless steel rod for a given time of 120 seconds, gives θ?₂ to be 100°° C. giving D_{T}=85°° C.

We can then say:
Q=mc D_{T}
Q=0.3×(4.2×10³)×85
Q=107.100J

Delivered energy (Power) from microwave if:
1 watt=1J/second.

Therefore, a 900 watt microwave delivers 900J/second.
In 120 seconds=900×120=108,000J (Total)

Target absorbed=107,100J of produced J. Therefore, absorbing 99.2%

Referring to FIG. 7 of the drawings, an exemplary embodiment of the third aspect of the present invention comprises a rectangular waveguide 700 providing a heating cavity having two adjustable end plates 701, 702, such that the length of the waveguide 700 can be adjusted, as required, using screw members 703, 704. In this exemplary embodiment of the invention, the heating cavity comprises a single mode waveguide 700 having a single heating location through which a pipe or channel 705 passes. Thus fluid to be heated flows in the pipe through the waveguide 700 and passes through the heating location or “hot spot”. The system may be an open-loop system in which water from a supply is heated as it passes through the heating cavity and then dispensed for use as required. Alternatively, it may be a closed-loop system in which the same body of fluid flows around in a loop, is heated within the heating cavity as it passes through and then passes through some form of heat exchanger (where it is cooled), before flowing back into the heating cavity.

The single mode waveguide 700 providing the heating cavity is achieved by tuning the end plates 701,702 to exactly one quarter wavelength (of the radiation source waveform) such that the radiation transmitted from the radiation source (in this case, magnetron 706) to the heating location is exactly one waveform 707, as shown. Any error in tuning the waveguide would result in the radiation source within the waveguide including or comprising a partial waveform, which would cause reflection of the source wave within the waveguide, thereby attenuating the radiation source wave and reducing the efficiency of the system.

Within the pipe or channel, there is provided one or more aerials 708. The or each aerial may comprise a metal rod, tube, wire or pipe, for example, and/or metal pieces or filings, but is in any event preferably (but not necessarily) a solid member (as opposed to reticulated such as mesh or wire wool). The aerial(s) may comprise an insulative core surrounded by a conductive material (for example, metal wire coiled around a carbon rod), but the invention would work equally well using an aerial comprising a metal member completely or partially covered in an insulative material, such as a plastic sheath or the like. This is because the aerial operates to concentrate the radiation source at the heating location, rather than absorbing the radiation so that it heats up and transfers heat to the fluid, as in some prior art arrangements.

It may be desirable, under some circumstances, to delay the flow of fluid through the heating cavity so that the fluid is in there long enough to be heated sufficiently. As stated above, this can be achieved by providing, for example, a helical pipe section within the cavity. Alternatively, some means for delaying fluid flow may be used. For example, an electronic sensor may be employed to monitor the temperature of fluid at the outlet, and cause a control system to adjust the fluid flow rate accordingly; or a mechanical cam may be used which can be rotated to selectively decrease the diameter of the pipe 705 inside or outside the heating cavity so as to reduce the fluid flow.

As stated above, a cooling fan (not shown) or similar means may be provided to draw cooling gas over the magnetron 708 so as to cool it, although it is envisaged in another embodiment of the invention, for pipe 705 to be wrapped around the magnetron 706 within the heating cavity, such that heat generated by the magnetron passes directly through the pipe to the fluid. A cooling fan may then also be provided to improve cooling efficiency (although this would not be essential in all cases).

The structure of a heating cavity according to an exemplary embodiment of the invention can be seen in more detail in FIGS. 8 to 10 of the drawings.

In an alternative embodiment, the heating cavity may instead comprise a multi-mode waveguide, such that there are a plurality of heating locations or “hot-spots” therein. The system may then be arranged to “train” the flow of fluid through each heating location and, possibly, reduce the fluid flow at one or more of those heating locations to allow the fluid thereat to be sufficiently heated.

It will be appreciated that a magnetron generally has a predetermined, somewhat limited, life. Thus, one embodiment of the invention may comprise a plurality of (preferably) single mode waveguides, each having a magnetron, and through each of which the fluid is arranged to flow. A control system is provided which causes a single heating cavity to be operated at any time (i.e. only one magnetron is energised at a time). The control system may, for example, be arranged to switch each heating cavity in turn, or switch one heating cavity on when another fails.

In general, embodiments of the present invention have been described above by way of examples only with reference to the accompanying drawings, and it will be apparent to a person skilled in the art that modifications and variations can be made to the described embodiments without departing from the scope of the invention as defined in the appended claims.

1. Fluid heating apparatus comprising a heating cavity and one or more radio frequency wave heating sources arranged to emit electromagnetic radiation into said heating cavity such that a body of fluid disposed therein or fluid flowing or passing therethrough is heated, the apparatus further comprising one or more aerials disposed within the body or flow of fluid to be heated, the or each aerial comprising a member arranged to transmit or receive electromagnetic waves.

2. Heating apparatus according to claim 1, wherein said fluid is a liquid (e.g. water).

3. Heating apparatus according to claim 1, wherein said heating source is electromagnetic radiation in the range between 3KH_{z} and 300 GH_{z}, more preferably 100 MH_{z} and 100 GH_{z}, yet more preferably 100 MH_{z} and 10 GH_{z}, and yet more preferably 300 MH_{z} and 3 GH_{z}, for example, a microwave heating source.

4. Heating apparatus according to claim 1, wherein said aerial or aerials is/are at least partially metal member(s).

5. Heating apparatus according to claim 4, wherein said metal member(s) comprise one or more solid members, such as a rod, tube, pipe, wire, metal pieces or filings.

6. Heating apparatus according to claim 1, wherein said aerial or aeriels each comprise an insulative member and at least one radiation absorption means affixed to or at least partially surrounding said insulative member.

7. Heating apparatus according to claim 1, wherein the or each aerial comprises a metal member at least partially surrounded or covered with an insulative material.

8. A method of heating fluid, comprising the steps of providing a heating cavity within which is disposed a body of fluid to be heated or through which fluid to be heated is caused to pass or flow, emitting radio frequency wave radiation into said heating cavity such that said fluid is heated thereby, and providing one or more aerials within said body or flow of fluid, the or each aerial comprising a member arranged to transmit or receive electromagnetic waves.

9. A method according to claim 8, wherein said fluid is a liquid (e.g. water).

10. Fluid heating apparatus comprising a heating cavity and a substantially fluid-tight pipe or channel within said heating cavity, the pipe or channel having an inlet and an outlet, means for causing fluid to flow or pass through said pipe or channel from said inlet to said outlet, and one or more radio frequency wave heating sources arranged to emit electromagnetic radiation into said heating cavity such that fluid is heated thereby as it flows or passes through said pipe or channel from said inlet to said outlet.

11. Heating apparatus according to claim 10, wherein said fluid is a liquid (e.g. water).

12. Heating apparatus according to claim 10, wherein said pipe or channel comprises a conduit of metal, plastic or any other suitable material.

13. Heating apparatus according to claim 10, further comprising one or more aerials disposed within the flow of fluid to be heated, the or each aerial comprising a member arranged to transmit or receive electromagnetic waves.

14. Heating apparatus according to claim 13, wherein said one or more aerials at least partially comprise one or more metal members.

15. Heating apparatus according to claim 13, wherein said one or more aerials at least partially comprise carbon, or other suitable non-metallic material.

16. Heating apparatus according to claim 14, wherein said one or more metal members comprise, or include one or more solid members, such as a rod, tube, pipe, wire, metal pieces or filings.

17. Heating apparatus according to claim 10, wherein said heating source is electromagnetic radiation in the range between 3 KH_{z} and 300 GH_{z}, more preferably 100 MH_{z} and 100 GH_{z}, yet more preferably 100 MH_{z} and 10 GH_{z}, and yet more preferably 300 MH_{z} and 3 GH_{z}, for example, a microwave heating source.

18. Apparatus according to claim 10, arranged to heat fluid to a variety of different (preferably selectable) temperatures.

19. Apparatus according to claim 18, arranged to heat fluid to a temperature in a range between 20° C. to 500° C.

20. Apparatus according to claim 10, arranged to sterilize fluid.

21. Apparatus according to claim 10, comprising control means for controlling variables of the apparatus, when in use, to produce a desired fluid temperature at the outlet.

22. Apparatus according to claim 10, wherein said fluid flows from a fluid supply means and is dispensed via means connected to, or in communication with said outlet.

23. Apparatus according to claim 10, comprising a closed loop system in which the same body of fluid flows into and out of said heating cavity, passes through a heat exchange means and then flows or passes back into said heating cavity via said inlet.

24. Apparatus according to claim 21, comprising sensor means for sensing the rate of flow of fluid into and/or through said pipe or channel, the control means being arranged to control the frequency of said one or more heating sources and/or said rate of flow of fluid so as to produce a desired fluid temperature at the outlet.

25. Apparatus according to claim 21, comprising a mechanical cam means for regulating the flow of fluid through said pipe or channel by selectively varying the diameter thereof.

26. Apparatus according to claim 21, comprising sensor means for sensing the fluid temperature at the outlet, the control means being arranged to control the frequency of said one or more heating sources and/or the rate of flow of fluid into and/or through said conduit so as to produce a desired fluid temperature at the outlet.

27. Apparatus according to claim 20, comprising an airtight storage tank for storing fluid sterilized by said apparatus until it is required for use.

28. Apparatus according to claim 10, wherein said channel or pipe comprises a helical or otherwise shaped tube or channel, or network of channels or tubes for reducing the flow rate of fluid through said channel or pipe from that at which it enters said channel or pipe.

29. Apparatus according to claim 10, comprising one or more channels or pipes.

30. Apparatus according to claim 10, wherein said one or more channels or pipes are formed of thermally conductive material.

31. Apparatus according to claim 10, comprising one or more waveguides to aid in the transmission and direction of the radio frequency waves emitted by the heating source towards the conduit through which the fluid to be heated is passing or flowing.

32. Apparatus according to claim 31, wherein said heating cavity comprises or includes a single mode waveguide.

33. Apparatus according to claim 31, wherein said heating cavity comprises or includes a multiple mode waveguide including a plurality of heating locations.

34. Apparatus according to claim 33, comprising means for slowing or delaying the flow of fluid through said heating cavity at one or more of said heating locations.

35. Apparatus according to claim 32, including means for stopping and holding a body of fluid at the or each heating location such that a fixed body of fluid is heated.

36. Apparatus according to claim 10, comprising a plurality of heating cavities, and means for reflectively switching between said heating cavities.

37. Apparatus according to claim 10, wherein commencement of flow of fluid triggers the operation of the radio frequency wave heating source.

38. Apparatus according to claim 10, comprising cooling means for cooling said heating source in operation.

39. Apparatus according to claim 10, wherein said channel or pipe is disposed adjacent said heating source, such that heat generated by said source is transferred to the fluid within or flowing or passing through said channel or pipe.

40. Apparatus according to claim 38, wherein said cooling means comprises a cooling fan for drawing cooling air across said heating source in operation.

41. Apparatus according to claim 40, wherein said air, once it has been drawn across said heating source, is used to aid in heating said fluid flowing or passing through said conduit.

42. Apparatus according to claim 10, wherein said apparatus is portable.

43. A method of heating fluid comprising the steps of providing a heating cavity and a substantially fluid-tight pipe or channel within said heating cavity, the pipe or channel having an inlet and an outlet, causing fluid to flow or pass through said pipe or channel from said inlet to said outlet, applying radio frequency wave radiation into said heating cavity around said pipe or channel such that fluid is heated thereby as it flows through said pipe or channel from said inlet to said outlet.

44. A method according to claim 43, wherein said fluid comprises a liquid (e.g. water).

45. A method according to claim 43, including the step of delaying the flow of fluid at one or more selected locations within said heating cavity where it is heated by said radio frequency wave radiation.

46. (canceled)

47. Heating apparatus for emitting heat into the surrounding atmosphere, said apparatus comprising a thermally conductive housing containing a body of fluid therein, when in use, and one or more radio frequency heating sources for heating said body of fluid in said housing, heat from said body of fluid being conducted to said housing and from said housing into the surrounding atmosphere.

48. Heating apparatus according to claim 47, wherein said fluid is a fluid, and more preferably water or a water-based fluid.

49. Heating apparatus according to claim 47, further comprising one or more aerials disposed in said body of fluid.

50. Heating apparatus according to claim 49, wherein said one or more aerials is/are or include metal member(s), and more preferably substantially solid metal members such as metal rods, pipes, tubes or wires, pieces of filings.

51. Heating apparatus according to claim 47, wherein said one or more radio frequency heat sources are supplied with electrical power from a mains supply, generator, and/or a battery supply.

52. Heating apparatus according to claim 47, comprising a control unit, which is preferably wireless, for controlling the operation thereof.

53. Heating apparatus according to claim 47, comprising a drainage plug for allowing said fluid to be drained out of said housing.

54. Heating apparatus according to claim 47, comprising a fill plug for introducing fluid into said housing.

55. Heating apparatus according to claim 47, including an expansion tank or similar vessel.

56. Heating apparatus according to claim 47, comprising means for cooling said one or more radio frequency heat sources, and/or means for venting warm air, and/or waveguide means for transferring to radio frequency waves into the fluid chamber defined by the internal confines of the housing causing the fluid therein to be heated.

57. Heating apparatus according to claim 47, comprising means for agitating the fluid within the housing, or causing it to circulate therein.

58. Heating apparatus according to claim 57, comprising a waveguide and radio frequency heating source, and means for causing the fluid to circulate within the housing, through said waveguide.

59. (canceled)
